(19) United States
(12) Patent Application Publication
(10) Pub. No.: US 2025/0234943 A1
(43) Pub. Date: Jul. 24, 2025

(54) ANTI-INFLAMMATORY GLOVES

(71) Applicant: Kossan Sdn. Bhd., Selangor (MY)

(72) Inventors: Lawrence Lim Siau Tian, Selangor (MY); Christian Wisbar, Selangor (MY); Yi Ming Ong, Selangor (MY); Eng Long Ong, Selangor (MY)

(73) Assignee: Kossan Sdn. Bhd., Selangor (MY)

(21) Appl. No.: 18/954,964

(22) Filed: Nov. 21, 2024

(30) Foreign Application Priority Data
Jan. 23, 2024 (MY) MY PI2024000496

(51) Int. Cl. A41D 19/00; A41D 31/02; B29C 41/14

(52) U.S. Cl. CPC A41D 19/0055; A41D 19/0006; A41D 31/02; B29C 41/14; A41D 2500/54

(57) ABSTRACT

The present invention relates to gloves with an anti-inflammatory formulation. The gloves comprise an elastomeric film (R) and at least one layer (C1, C2) of a formulation comprising an anti-inflammatory agent wherein the anti-inflammatory agent is glycyrrhizinic acid and its salts. At least one layer of the formulation is formulated for the slow release of the anti-inflammatory agent.

### FIELD OF INVENTION

The invention relates to gloves with an anti-inflammatory formulation.

### BACKGROUND

Workers in the health care and food handling industry are required to wear protective gloves for occupational health and hygiene reasons. These individuals therefore are more susceptible to hand skin conditions as the hands of most individuals start to perspire within minutes when rubber gloves are worn. This makes it necessary for them to wash their hands after using gloves. Individuals who wear gloves frequently or over prolonged periods of time often experience hand skin problems such as dryness which generally increases skin sensitivity/irritability. While the application of moisturiser and emollients may help relieve dryness, they can also lead to oily residues. In cases where the individual's hands have a pre-existing skin irritation, moisturiser and emollients provide limited relief and the condition may not resolve without additional treatment. Mitigating occupational health problems benefits the worker, employer as well as third parties (patient, consumer). Apart from the health benefit for the worker, cost reduction due to reduced occupational health-related staff turnover can be expected, which in turn may result in improved service or product quality.

The extract of Glycyrrhiza glabra roots, known as liquorice, is commonly used in sweets, supplements, and in traditional medicine. One of the major components of the extract, glycyrrhizinic acid, provides beneficial health effects acting as a non-steroidal anti-inflammatory (NSAI). The aforementioned NSAI effect is not confined to oral consumption, as studies have shown that, when applied to skin, glycyrrhizinic acid helps to reduce skin redness and irritation commonly associated with various ailments, such as Rosacea, Psoriasis, and acne. Glycyrrhizinic acid can be found in personal care products, such as facial moisturiser/lotion, anti-aging treatment, sunscreen, acne treatment, cleanser, foundation, skin fader/lightener, facial masque, and eye cream. The presence of glycyrrhizinic acid or its salts (for example, Dipotassium glycyrrhizinate, herein collectively referred to as DPG) in gloves mitigates or prevents the impact of skin dryness and thus provides a soothing effect to the wearer.

An aim of the invention therefore is to provide gloves coated with an anti-inflammatory formulation capable of alleviating adverse effects of sensitised skin by preserving the skin barrier.

### SUMMARY OF INVENTION

In one aspect of the invention there is provided an anti-inflammatory glove comprising;
an elastomeric film wherein the film is formed from an elastomer dispersion; and
at least one layer (C1, C2) of a formulation comprising an anti-inflammatory agent coated on the elastomeric film;
characterised in that the at least one layer of the formulation is formulated for the slow release of the anti-inflammatory agent.

Advantageously, the inclusion of one or more layers of the formulation allows the alteration of the release rate of the anti-inflammatory agent.

Preferably the anti-inflammatory agent is glycyrrhizinic acid and its salts.

In one embodiment the formulation further comprises humectant, emollient, cooling agent and wetting agent.

In one embodiment the formulation may further comprise a preservative agent.

In one embodiment the at least one layer of the formulation is coated on a skin-contacting side of the elastomeric film.

In one embodiment a first layer of the formulation further comprises a donning polymer that acts as an embedding matrix for the anti-inflammatory agent.

In one embodiment the embedding matrix allows the slow release of the anti-inflammatory agent from the coated elastomeric film to the skin.

Advantageously, the first layer of the formulation is prepared by embedding the anti-inflammatory agent into the donning polymer through which the anti-inflammatory agent needs to migrate in order to reach the skin.

Advantageously, the donnability polymer exhibits good substrate wetting to the elastomeric film surface in order to form a continuous layer and as such the first layer of the formulation may also aid donning of gloves by reducing friction between the elastomeric film and skin.

In one embodiment a second layer of the formulation is formulated without a donning polymer allowing the anti-inflammatory agent to be released instantly from the coated elastomeric film to the skin.

Advantageously, the inclusion of both the first and second layers allows the manufacture of gloves with a tailored release potential of the anti-inflammatory agent. This is especially important as the duration and frequency of glove usage is dependent on its application.

In one embodiment the average thickness of the first layer of the formulation is within the range of 1-5 μm.

Preferably the amount of glycyrrhizinic acid and its salts is within the range of 0.5-500 μg/cm² at the skin-contacting side of the elastomeric film.

In one aspect of the invention there is provided a method for producing the anti-inflammatory glove comprising the step of dip-coating or spraying an elastomeric film with at least one layer of a formulation comprising an anti-inflammatory agent;
characterised in that the at least one layer of the formulation is formulated for the slow release of the anti-inflammatory agent.

Advantageously, further washing steps after coating the elastomeric film with at least one layer of the formulation are not required as the coating additives are skin-friendly.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 illustrates a cross-section of the glove layers.

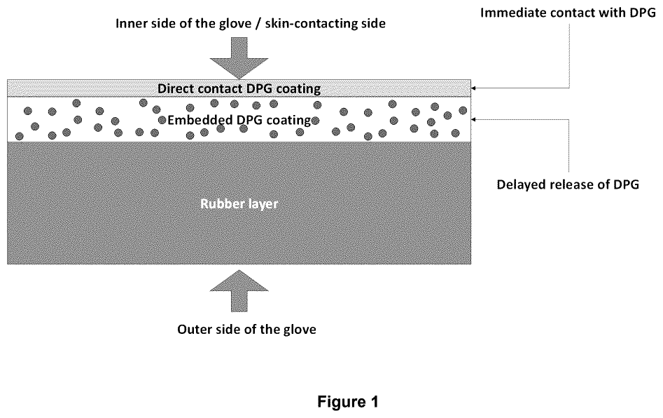

FIG. 2 illustrates a scanning electron microscope (SEM) image of a cross-section of a glove coated with a single layer of glycyrrhizinic acid or its salts embedded in a donning polymer.

FIG. 3 illustrates a dip-coating process to coat gloves with a single or multiple layers of glycyrrhizinic acid or its salts.

FIG. 4 illustrates the percentage of skin hydration following the usage of gloves coated with glycyrrhizinic acid or its salts in comparison to without the usage of gloves.

FIG. 5 illustrates the percentage of skin hydration following the usage of gloves coated with donning polymer in comparison to without the usage of gloves.

### DETAILED DESCRIPTION

The present invention discloses a type of skin-benefitting gloves (SQINTHERA). More specifically the gloves are coated with an anti-inflammatory formulation comprising glycyrrhizinic acid and its salts (DPG) by having the formulation present at the skin-contacting side of the gloves (inner side of gloves). DPG has beneficial effects to the skin, especially when the wearer's skin is suffering from a disease or has been injured physically (scratch, UV radiation) or chemically (insult with surfactants that are commonly found in detergent or cleansing formulations).

### Glove Structure

The gloves of the present invention comprise an elastomeric film (rubber layer, R) wherein the elastomeric film is coated with one or more layers (C1, C2) of an anti-inflammatory formulation prepared using the extract of Glycyrrhiza glabra wherein the main component of the extract is glycyrrhizinic acid and its salts (DPG). One or more layers (C1, C2) of the formulation are coated on the skin-contacting side of the elastomeric film (Error! Reference source not found.). The inclusion of one or more layers of the formulation allows the alteration of the release rate of DPG.

The elastomeric film can be formed from an elastomer dispersion such as natural rubber latex, synthetic polyisoprene latex, polyurethane dispersions, polychloroprene latex, carboxylated or non-carboxylated styrene/butadiene latex or carboxylated or non-carboxylated acrylonitrile/butadiene latex. The elastomeric film is crosslinked by sulphur crosslinking or alternatively through crosslinking that does not employ sulphur crosslinking agents.

For example, the elastomeric dispersion can be formed from a carboxylated acrylonitrile/butadiene latex, comprising 25-30 wt % of a structural unit derived from acrylonitrile, 62-71 wt % of a structural unit derived from butadiene and 4-8 wt % of a structural unit derived from an unsaturated carboxylic acid. Preferably the dispersion does not comprise sulphur cross-linking agents.

A first layer (C1) is prepared by embedding DPG into a polymeric binder through which DPG needs to migrate in order to reach the skin of the wearer. Said polymeric binder also known as a donning polymer may comprise styrene acrylic dispersions or polyurethane dispersions, are commercially available as ready-to-use formulations as disclosed in EP1309658B1 for example. As such, the first layer may also aid donning of gloves by reducing friction between the elastomeric film and the wearer's skin.

A second layer (C2) differs from the first layer in that it does not consist of a polymeric binder to embed DPG and thus DPG is not slowly released from the second layer (i.e., the wearer's skin is receiving the entire dose of DPG that is contained in this layer upon contact). With the presence of layer C2, it is noted that the donnability of the gloves is not impaired. If the intended use of the glove requires fast release of DPG, only layer C2 may contain DPG. In this case, the layer is applied after the glove surface has been modified to reduce friction between rubber and skin by a donning polymer or alternatively by chlorination.

The inclusion of both layers C1 and C2 allows the manufacture of gloves with a tailored DPG release potential. Tailored DPG release potential is especially important as the duration and frequency of glove usage is dependent on its application; a medical professional who needs to attend to many patients a day is required to change gloves between each patient while in the food industry a single pair of gloves may be worn for many hours.

The formulation of layers C1 and C2 are different. In addition to DPG, both layers may contain moisturising components such as humectants, emollients, occlusives as well as fragrance or cooling agents. The slow release that is applicable to DPG for layer C1 would also be applicable to the other agents found in the formulation. The donning polymer serves as the embedding matrix for active components of the formulation once water is evaporated (Error! Reference source not found.).

TABLE 1
Table 1: Formulation of layer C1

| Component | Amount | Function |
|---|---|---|
| Donning polymer | 20.0% | Polymeric binder |
| Urea | 0-3.5% | Humectant |
| Glycerol | 0-3.5% | Emollient |
| Cooling agent | 0-1.0% | Imparts cooling sensation |
| DPG | 0.1-1.5% | Anti-inflammatory agent |
| Total non-volatile content | 20.1-29.5% | |

The slow-release potential of DPG is directly proportional to the coating thickness of the first layer C1. The average thickness of the first layer C1 is within the range of 1-5 μm.

The formulation of layer C2 (Table 2) does not contain the donning polymer and in order to achieve and maintain substrate wetting, the addition of wetting agents (present in the cooling agent) is required whereby the substrate is either a rubber layer that is chlorinated or coated with layer C1.

TABLE 2
Table 2: Formulation of layer C2

| Component | Amount | Function |
|---|---|---|
| DPG | 0.1-1.5% | Anti-inflammatory agent |
| Urea | 0-3.0% | Humectant |
| Glycerol | 0-3.0% | Emollient |
| Cooling agent | 0.1-0.5% | Imparts cooling sensation |
| Total non-volatile content | 0.2-8.0% | |

*water is utilised for mixing and total non-volatile content adjustment

For layers C1 and C2 to be utilised in the coating process of gloves, dilutions of the formulations provided in Table 1 and 2 need to be made as those formulations are intermediate concentrates for transport and storage. The wettability of the rubber layer surface of gloves that is to be coated depends on many factors such as the nature of the rubber, whether the gloves are chlorinated or non-chlorinated, level and nature of other rubber additives such as antiozonants, wax dispersions and the moisture content of the rubber at the moment when the rubber layer surface is brought in contact with the coating formulations.

Fine-tuning of the glove coating formulation leads to a non-volatile content of 1.5-3.5% for the dilution of layer C1. The exact value is dependent on factors that affect the wetting of the substrate such as substrate dryness, the nature of the substrate (i.e. polarity, surface energy) and also environmental conditions (temperature, humidity). Similarly for layer C2 a non-volatile content of 0.5-4.5% is usually necessary in order to obtain the targeted surface concentration of Dipotassium glycyrrhizinate.

A clear and stable cooling agent formulation using menthyl lactate as the cooling agent that can be added at a desired concentration into the formulations of layer C1 or C2 is provided in Table 3. Using this formulation, menthol or menthyl lactate can interchangeably be used.

TABLE 3
Table 3: Cooling agent formulation

| Component | Amount | Function |
|---|---|---|
| Menthyl lactate | 3.0-3.5% | Cooling agent |
| 2-propanol | 16.0-20.0% | Solvent |
| Polyoxyethylene (20) | 0.5-1.5% | Stabilizer, cooling co-agent |
| sorbitan monooleate | | |
| Na-Dioctyl sulphosuccinate | 5.0-9.0% | Hydrotrope, wetting agent |
| Total non-volatile content | 8.5-14.0% | |

*water is utilised for mixing and total non-volatile content adjustment

The cooling agent formulation is prepared in a simple mixing manner and the final formulation can provide a cooling sensation that is scented (mint smell from menthol) or unscented (using menthyl lactate). If a cooling sensation is not required the wetting agents may be added directly into the formulation of layer C2.

### Example 1

Table 4 lists the percentage by weight of the active ingredients found in the dry coating layer of gloves (C1, C2 or C1 and C2).

TABLE 4
Table 4: Overall composition of all coating layers after drying.

| Material | Cumulative % Weight in all layers |
|---|---|
| Dipotassium glycyrrhizinate | 5.04 |
| Menthyl lactate | 1.91 |
| Glycerol | 43.18 |
| Urea | 43.18 |
| Wetting agent | 5.09 |
| Cooling co-agent | 0.67 |
| Preservative | 0.93 |

Preferably the amount of DPG is 0.5-500 μg/cm² at the skin-contacting side of the elastomeric film.

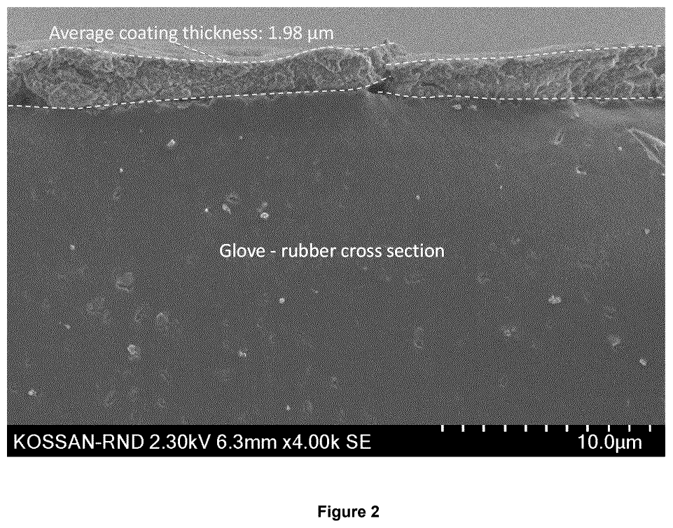

FIG. 2 illustrates a scanning electron microscope (SEM) image of a cross-section of a glove coated with a single layer of DPG (C1) embedded in a donning polymer. Complete coverage of the inner side of a glove is achieved with an average thickness of 1.98 μm. The complete coverage can be visually detected as well as by assessing the friction of the inner glove surface.

The required concentration of DPG and cooling agent and other components in the respective formulations is a result of the targeted concentration per surface area. By producing slow-release gloves (layer C1 only) without moisturiser such as glycerol or urea, it was found that DPG surface concentrations as low as 4.0 μg/cm² resulted in measurable improvements of the wearer's skin after a chemical insult with 10% SLS (sodium lauryl sulphate).

### Coating Process

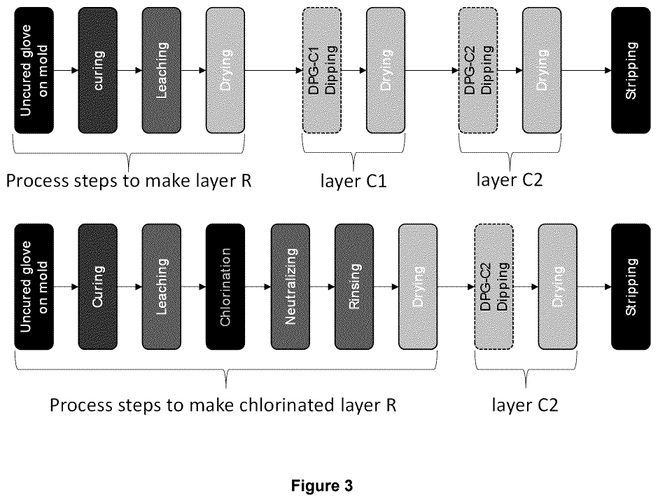

FIG. 3 illustrates a dip-coating process to coat gloves with a single or multiple layers of DPG. During the manufacturing of the gloves, rubber layer is formed first followed by layer C1 and then layer C2.

Through the dip-coating process, layers C1 and C2 are coated onto the gloves by dipping the gloves into the prepared C1 and C2 formulations. The surface concentration of DPG at the skin-contacting side of the glove is controlled by the concentration of DPG, the rheologic characteristics and the rate of withdrawal of DPG from the coating formulations.

If only a single layer (layer C2) containing DPG is to be coated on gloves, a spraying process can be employed. This process is carried out in a tumbler and as such causes both the inside and outside of the glove to receive a coating of layer C2. The amount of DPG is controlled by the concentration of DPG and the quantity that is sprayed into the tumbler. As the glove is manufactured without layer C1, an alternative method of reducing friction is employed (a surface treatment commonly known as chlorination) after which layer C2 can be added directly onto the rubber layer.

In both processes further washing steps after the application of layers C1 and C2 via dipping or spraying are not required to ensure no DPG is lost (the coating additives utilised in the formulations are skin friendly so no further washing step is needed).

### Results

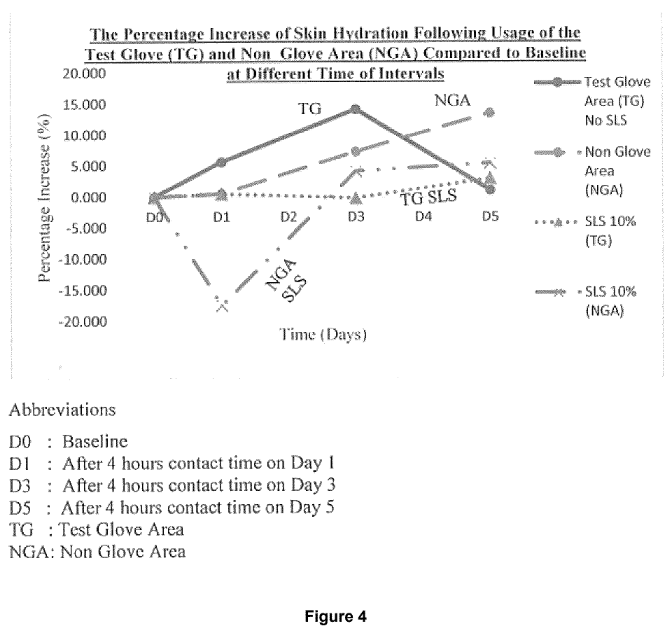

FIG. 4 illustrates the percentage of skin hydration following the usage of gloves coated with glycyrrhizinic acid or its salts in comparison to without the usage of gloves. At 32.5 μg/cm² DPG, it can be seen that the moisture content of skin insulted with 10% sodium lauryl sulfate (SLS; a harsh synthetic detergent and foaming agent commonly found in hygiene products) did not change over the course of 5 days (triangle dotted line).

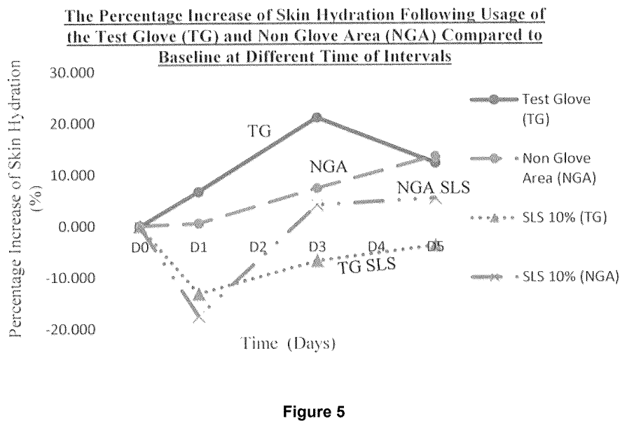

FIG. 5 illustrates the percentage of skin hydration following the usage of gloves coated with donning polymer (blank glove) in comparison to without the usage of gloves. In comparison to the blank glove, the DPG glove has negated the damage that was caused by 10% sodium lauryl sulfate (FIG. 4). In FIGS. 4 and 5, the triangle dotted lines represent the test gloves on SLS insulted areas, while the combination dash-dotted lines are insulted areas that were occluded with polythene instead of a glove (NGA=non-glove area). It can be clearly seen that the trends of the insulted blank glove and the insulted non-glove area have very similar results, on the same day when the insult was carried out the moisture level of the affected areas dropped by around 15% and subsequently recovered on day 3. At day 5 the blank glove has still not fully recovered when comparing to the non-glove area while DPG glove on the insulted area (triangle dotted lines, FIG. 4) has not shown any significant difference in skin moisture content of the insulted area throughout the test. As such the DPG gloves have shown a skin barrier recovery effect, which is an unexpected result from DPG's anti-inflammatory properties.

It will be appreciated by persons skilled in the art that the present invention may also include further additional modifications which does not affect the overall functioning of the invention.

1. An anti-inflammatory glove comprising;
an elastomeric film (R) wherein the film is formed from an elastomer dispersion; and
at least one layer (C1, C2) of a formulation comprising an anti-inflammatory agent coated on the elastomeric film;
characterised in that the at least one layer of the formulation is formulated for the slow release of the anti-inflammatory agent.

2. The anti-inflammatory glove according to claim 1, wherein the anti-inflammatory agent is glycyrrhizinic acid and its salts.

3. The anti-inflammatory glove according to claim 1, wherein the formulation further comprises humectant, emollient, cooling agent, preservative and wetting agent.

4. The anti-inflammatory glove according to claim 1, wherein the at least one layer of the formulation is coated on a skin-contacting side of the elastomeric film.

5. The anti-inflammatory glove according to claim 1, wherein a first layer (C1) of the formulation further comprises a donning polymer which acts as an embedding matrix for the anti-inflammatory agent.

6. The anti-inflammatory glove according to claim 5, wherein the embedding matrix allows the slow release of the anti-inflammatory agent from the elastomeric film to the skin.

7. The anti-inflammatory glove according to claim 1, wherein a second layer (C2) of the formulation is formulated without a donning polymer allowing the anti-inflammatory agent to be released instantly from the elastomeric film to the skin.

8. The anti-inflammatory glove according to claim 2, wherein the amount of glycyrrhizinic acid and its salts is preferably within the range of 0.5-500 μg/cm².

9. A method for producing the anti-inflammatory glove of claim 1 comprising the step of dip-coating or spraying an elastomeric film (R) with at least one layer (C1, C2) of a formulation comprising an anti-inflammatory agent;
characterised in that the at least one layer of the formulation is formulated for the slow release of the anti-inflammatory agent.
